(19) United States
(12) Patent Application Publication
(10) Pub. No.: US 2019/0338907 A1
(43) Pub. Date: Nov. 7, 2019

(54) VEHICLE LAMP INTEGRATING A TURN SIGNAL LIGHT, A SIDE MARKER LIGHT AND A HEADLIGHT

(71) Applicant: MAGNA MIRRORS (TAICANG) AUTOMOTIVE TECHNOLOGY CO., LTD., Jiangsu (CN)

(72) Inventors: Zhenxing MI, Jiangsu (CN); Jun YE, Jiangsu (CN)

(21) Appl. No.: 16/116,160

(22) Filed: Aug. 29, 2018

(30) Foreign Application Priority Data
May 4, 2018 (CN) 201820659363.X

(51) Int. Cl. F21S 41/24; F21S 43/235; B60Q 1/04; B60Q 1/26; F21S 43/20; F21S 41/141

(52) U.S. Cl. CPC F21S 41/24; F21S 43/235; B60Q 1/04; F21W 2107/10; F21S 43/26; F21S 41/141; B60Q 1/2665

(57) ABSTRACT

The invention relates to a vehicle lamp which integrates the turn signal light, the side marker light and the headlight comprising: a headlight circuit board, a second circuit board, a reflector panel, a transparent light guide, a mask and a housing, said headlight circuit board is provided with a headlight light source facing said reflector panel, said second circuit board is provided with a second light source facing said transparent light guide, and said transparent light guide is provided with optical stripes for refracting or reflecting said second light source, and said second circuit board and said headlight circuit board are disposed between said reflector panel and said housing, said reflector panel and said transparent light guides are all connected to said mask. The vehicle lamp which integrates the turn signal light, the side marker light and the headlight of the invention has beautiful appearance, light weight and suitable for large-scale promotion and application.

### FIELD OF THE TECHNOLOGY

The invention generally relates to the technical field of automobile parts, in particular to the technical field of automobile lamps. The invention is particularly to an automobile lamp which integrates a turn signal, a side marker light and a headlight.

### BACKGROUND OF THE INVENTION

The current car's turn signals, side marker lights, and headlights are three kinds of lights separating from each other, resulting in a larger amount of space and cost to install and manufacture. Modern vehicles are being manufactured to become more and more lightweight, and are required to be inexpensive. Therefore, there is a need for the versatility of automotive luminaries.

Therefore, it is necessary to provide an automobile lamp having three functions, and has the advantages of simple structure, reliable performance, facilitating vehicle weight reduction, low cost, and beautiful appearance.

### SUMMARY OF THE INVENTION

The object of the present invention is to overcome the above-mentioned shortcomings of the prior art, and to provide an automobile lamp which is suitable for large-scale popularization and application, which is a combination of a turn signal light, a side marker light and a headlight.

In order to achieve the above object, a automobile lamp of the present invention integrating a turn signal light, a side marker light and a headlight has the following structure:

The vehicle lamp integrating turn signal lights, side marker lights and headlights comprises a headlight circuit board, a second circuit board, a reflector panel, a transparent light guide, a mask and a housing. The headlight circuit board is provided with a headlight light source facing the reflector panel, the second circuit board is provided with a second light source facing the transparent light guide, and the transparent light guide is provided with optical stripes for refracting or reflecting the second light source, and the second circuit board and the headlight circuit board are disposed between the reflector panel and the housing, the reflector panel and the transparent light guides are all connected to the mask.

The second light source of the vehicle lamp which integrates the turn signal light, the side marker light and the headlight is a light source integrating the turn signal light source and the side marker light source.

The headlight source of the vehicle lamp which integrates the turn signal light, the side marker light and the headlight is a first LED light source, and the second light source is a second LED light source, and the first LED light source and the second LED light source has a different color or brightness.

The headlight circuit board, the second circuit board and the transparent light guide of the vehicle lamp which integrates the turn signal light, the side marker light and the headlight, are all fixedly connected to the housing.

The reflector panel of the vehicle lamp which integrates the turn signal light, the side marker light and the headlight is disposed on the housing.

The mask of the vehicle lamp which integrates the turn signal light, the side marker light and the headlight is welded to the housing.

The transparent light guide of the vehicle lamp which integrates the turn signal light, the side marker light and the headlight is fixed on the housing.

Outer edge of the housing of the vehicle lamp which integrates the turn signal light, the side marker light and the headlight has at least three holes for welding bolt to fixedly connect with bottom housing of a rear view mirror of a vehicle.

The housing of the vehicle lamp which integrates the turn signal light, the side marker light and the headlight is arranged to be inserted into bottom housing of a rear view mirror of a vehicle.

The mask of the vehicle lamp which integrates the turn signal light, the side marker light and the headlight is a transparent mask or a translucent mask.

The mask of the vehicle lamp which integrates the turn signal light, the side marker light and the headlight is welded to the housing by means of vibration friction welding.

The vehicle lamp which integrates the turn signal light, the side marker light and the headlight is provided with at least four headlight light sources and at least two second light sources.

The vehicle lamp which integrates the turn signal light, the side marker light and the headlight in the invention changes the conventional arrangement for separating the three lights from each other, and integrates those three lights with different functions together, including steering indicator function, wheel eyebrow warning function, front search indication function, making the vehicle lightweight with ingenious design, simple structure and reliable performance advantages and solving the problem of insufficient internal space of the vehicle. Not only can the vehicle lamp meet the requirements of light type and illumination, but also obtain better visual appearance through the refraction and reflection of light. Therefore, the vehicle lamp which integrates the turn signal light, the side marker light and the headlight of the invention has beautiful appearance, light weight and suitable for large-scale promotion and application.

### BRIEF DESCRIPTION OF THE DRAWINGS

FIG. 1 is a schematic structural view of a vehicle lamp which integrates the turn signal light, the side marker light and the headlight according to the present invention.

FIG. 2 is a front view of an embodiment of a vehicle lamp which integrates the turn signal light, the side marker light and the headlight according to the present invention.

FIG. 3 is a top view of an embodiment of a vehicle lamp which integrates the turn signal light, the side marker light and the headlight according to the present invention.

### LIST OF REFERENCE NUMERALS

1 mask
2 second circuit board
3 headlight circuit board
4 reflector panel
5 transparent light guide
6 housing
7 second light source
8 headlight source
9 holes for welding bolt

### DETAILED DESCRIPTION

In order to understand the technical content of the present invention clearly, the present invention is further exemplified by reference to the following example.

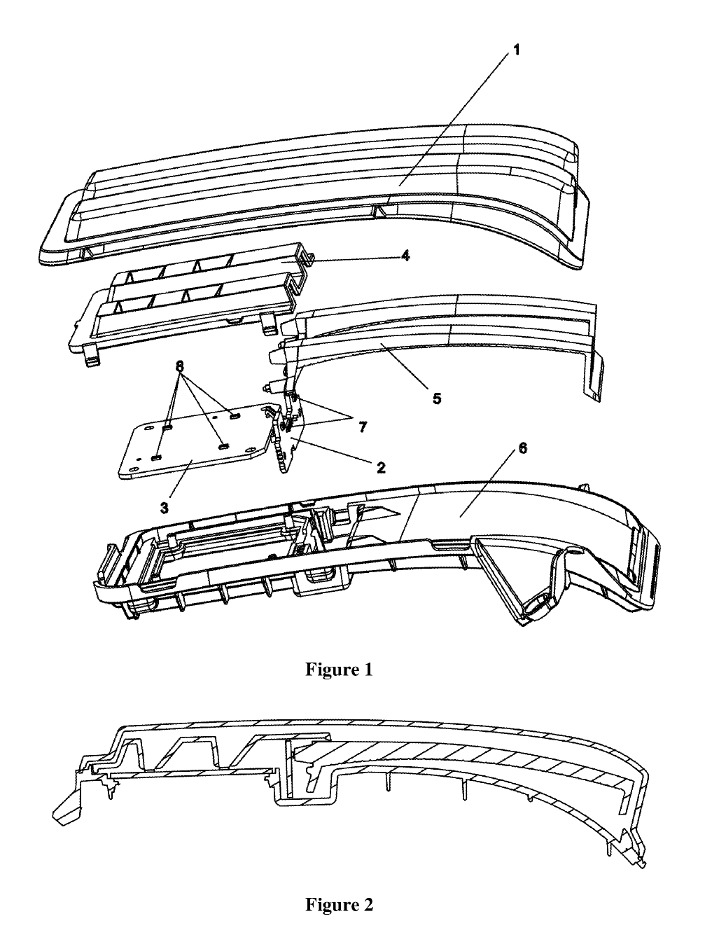

As shown in FIG. 1 to 3, the vehicle lamp integrating turn signal lights, side marker lights and headlights comprises a headlight circuit board 3, a second circuit board 2, a reflector panel 4, a transparent light guide 5, a mask 1 and a housing 6. The headlight circuit board 3 is provided with a headlight light source 8 facing the reflector panel 4, the second circuit board 2 is provided with a second light source 7 facing the transparent light guide 5, and the transparent light guide 5 is provided with optical stripes for refracting or reflecting the second light source 7, and the second circuit board 2 and the headlight circuit board 3 are disposed between the reflector panel 4 and the housing 6, the reflector panel 4 and the transparent light guides 5 are all connected to the mask 1.

The second light source 7 of the vehicle lamp which integrates the turn signal light, the side marker light and the headlight is a light source integrating the turn signal light source and the side marker light source.

The headlight source 8 of the vehicle lamp which integrates the turn signal light, the side marker light and the headlight is a first LED light source, and the second light source 7 is a second LED light source, and the first LED light source and the second LED light source has a different color or brightness.

The headlight circuit board, the second circuit board and the transparent light guide 5 of the vehicle lamp which integrates the turn signal light, the side marker light and the headlight, are all fixedly connected to the housing 6.

The reflector panel 4 of the vehicle lamp which integrates the turn signal light, the side marker light and the headlight is disposed on the housing 6.

The mask 1 of the vehicle lamp which integrates the turn signal light, the side marker light and the headlight is welded to the housing 6.

The transparent light guide 5 of the vehicle lamp which integrates the turn signal light, the side marker light and the headlight is fixed on the housing 6.

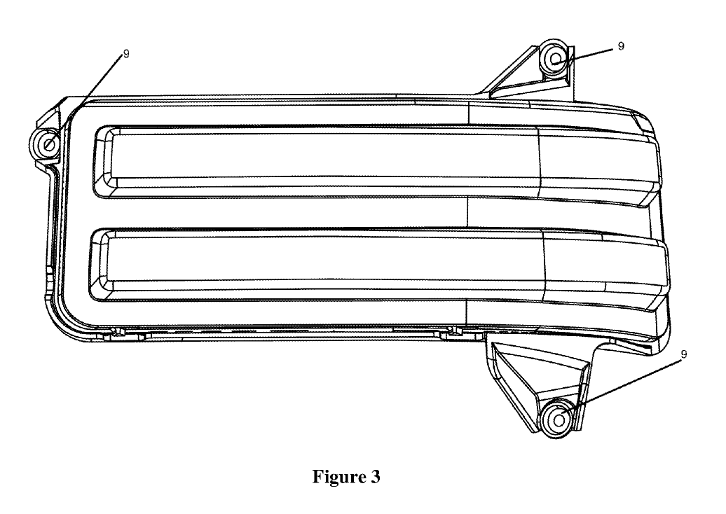

Outer edge of the housing 6 of the vehicle lamp which integrates the turn signal light, the side marker light and the headlight has at least three holes 9 for welding bolt to fixedly connect with bottom housing of a rear view mirror of a vehicle, as shown in FIG. 3.

The housing 6 of the vehicle lamp which integrates the turn signal light, the side marker light and the headlight is arranged to be inserted into bottom housing of a rear view mirror of a vehicle.

The mask 1 of the vehicle lamp which integrates the turn signal light, the side marker light and the headlight is a transparent mask or a translucent mask.

The mask of the vehicle lamp which integrates the turn signal light, the side marker light and the headlight is welded to the housing by means of vibration friction welding.

The vehicle lamp which integrates the turn signal light, the side marker light and the headlight is provided with at least four headlight light sources, and at least two second light sources.

In a specific embodiment, the number of the headlight source 8 and the second source 7 in the vehicle lamp integrating turn signal lights, side marker lights and headlights can be adjusted according to actual needs.

Preferably, four headlight light sources 8 are provided, and two second light sources 7 are provided.

In a specific embodiment, the light emitted by the headlight light source 8 and the second light source 7 respectively passes through the reflector panel 4 and the window on the transparent light guide 5.

The vehicle lamp which integrates the turn signal light, the side marker light and the headlight in the invention changes the conventional arrangement for separating the three lights from each other, and integrates those three lights with different functions together, including steering indicator function, wheel eyebrow warning function, front search indication function, making the vehicle lightweight with ingenious design, simple structure and reliable performance advantages and solving the problem of insufficient internal space of the vehicle. Not only can the vehicle lamp meet the requirements of light type and illumination, but also obtain better visual appearance through the refraction and reflection of light. Therefore, the vehicle lamp which integrates the turn signal light, the side marker light and the headlight of the invention has beautiful appearance, light weight and suitable for large-scale promotion and application.

In the present specification, the present invention has been described according to the particular embodiments. But it is obvious that these embodiments can be modified or changed without departure from the spirit and scope of the present invention. Therefore, the specification described above is exemplary only and not intended to be limiting.

I claim:

1. A vehicle lamp integrating turn signal lights, side marker lights and headlights, comprising: a headlight circuit board, a second circuit board, a reflector panel, a transparent light guide, a mask and a housing,
said headlight circuit board is provided with a headlight light source facing said reflector panel, said second circuit board is provided with a second light source facing said transparent light guide, and said transparent light guide is provided with optical stripes for refracting or reflecting said second light source, and said second circuit board and said headlight circuit board are disposed between said reflector panel and said housing, said reflector panel and said transparent light guides are all connected to said mask.

2. A vehicle lamp integrating turn signal lights, side marker lights and headlights according to claim 1, wherein said second light source is a light source integrating the turn signal light source and the side marker light source.

3. A vehicle lamp integrating turn signal lights, side marker lights and headlights according to claim 1, wherein said headlight source is a second LED light source, and said first LED light source and said second LED light source has a different color or brightness.

4. A vehicle lamp integrating turn signal lights, side marker lights and headlights according to claim 1, wherein said headlight circuit board, said second circuit board and said transparent light guide are all fixedly connected to said housing.

5. A vehicle lamp integrating turn signal lights, side marker lights and headlights according to claim 1, wherein said reflector panel is disposed on said housing.

6. A vehicle lamp integrating turn signal lights, side marker lights and headlights according to claim 1, wherein said mask is welded to said housing.

7. A vehicle lamp integrating turn signal lights, side marker lights and headlights according to claim 1, wherein said transparent light guide is fixed on said housing.

8. A vehicle lamp integrating turn signal lights, side marker lights and headlights according to claim 1, wherein said Outer edge of said housing has at least three holes for welding bolt to fixedly connect with bottom housing of a rear view mirror of a vehicle.

9. A vehicle lamp integrating turn signal lights, side marker lights and headlights according to claim 1, wherein said housing is arranged to be inserted into bottom housing of a rear view mirror of a vehicle.

10. A vehicle lamp integrating turn signal lights, side marker lights and headlights according to claim 1, wherein said mask is a transparent mask or a translucent mask.

11. A vehicle lamp integrating turn signal lights, side marker lights and headlights according to claim 6, wherein said mask is welded to said housing by means of vibration friction welding.

12. A vehicle lamp integrating turn signal lights, side marker lights and headlights according to claim 1, wherein said vehicle lamp is provided with at least four headlight light sources and at least two second light sources.
